(19) United States
(12) Patent Application Publication
(10) Pub. No.: US 2005/0192769 A1
(43) Pub. Date: Sep. 1, 2005

(54) Process for evaluating a signal from a motor vehicle environment sensor

(76) Inventor: Alexander von Reyher, Esslingen (DE)

Correspondence Address: PENDORF & CUTLIFF, 5111 MEMORIAL HIGHWAY, TAMPA, FL, 33634-7356, US

(21) Appl. No.: 11/059,851

(22) Filed: Feb. 17, 2005

(30) Foreign Application Priority Data
Feb. 20, 2004 (DE) 10 2004 008 866.7

(51) Int. Cl. G01D 18/00

(52) U.S. Cl. 702/104; 340/425.5; 342/54; 342/70; 342/146; 180/167

(57) ABSTRACT

The invention concerns a process for evaluating the signal of an environment sensor of a motor vehicle, wherein from the signal lag time an offset of this signal is determined as well as an incline of the roadway, in that the signal is subject to a first filtering with a first time constant, in order to determine the incline of the roadway, and in that the signal is subject to a further filtering with a second time constant, in order to determine a possible offset of the signal, wherein, as the input of the filter for determining the incline of the roadway, a measurement signal adjusted by the output of the second filter is used. In certain cases, from the drive dynamic input values, with use of a drive dynamic model, a drive dynamic associated component of the pitch and/or roll angle of the motor vehicle can be determined, wherein the input signal of the filter for determining the incline of the roadway is obtained, in that, from the measurements signal adjusted by the output of the second filter, further the drive dynamic associated components of the pitch and/or roll angle are subtracted. In the design of the model, in certain cases, the first filter can be completely dispensed with.

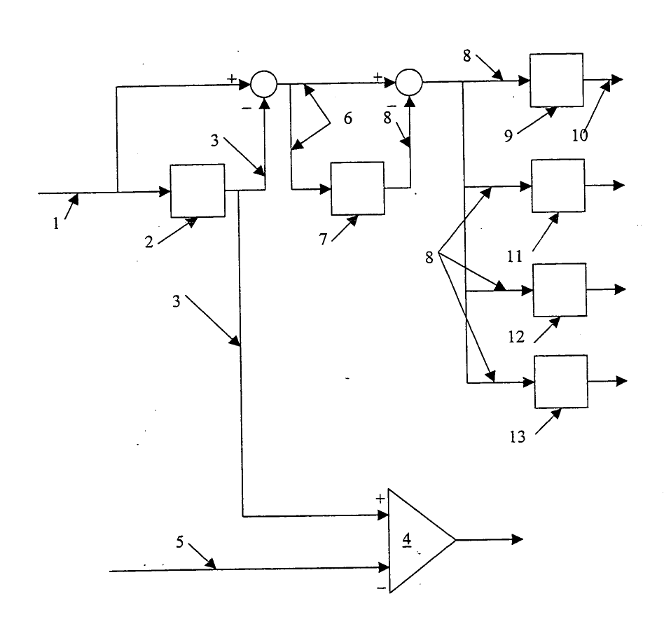

### BACKGROUND OF THE INVENTION

1. Field of the Invention

The invention concerns a process for evaluating a signal from a motor vehicle environment sensor according to the precharacterizing portion of Patent claim 1.

2. Related Art of the Invention

Processes of this type are known, for example from DE 101 41 294 A1. In accordance therewith, information regarding the current attitude of the vehicle, in particular during braking or acceleration processes, cornering and/or uneven weight distribution, is taken into consideration in the framework of signal evaluation. Therewith, changes are detected in the plane in which the sensor emits relative to the roadway.

This type of sensor is generally known as an optical sensor, such as, for example, the so-called LIDAR-Sensor. An optical sensor of this type provides distance measurements within a certain angle of beam spread and with a certain angular resolution. A laser beam is emitted, and the time (time lag or elapsed time) between the emission and the reception of the echo is used for determining the distance of the reflecting object. Some of these sensors do not measure in only one single plane, but rather make measurements in up to six planes.

The present invention is concerned with the task of improving signal evaluation.

### SUMMARY OF THE INVENTION

According to the present invention, this task is solved in accordance with claim 1 in that, from the time lag or signal delay an offset of the signal is determined as well as an incline or bank of the roadway, in that the signal is subjected to a first filtering with a first time constant, in order to determine the incline or bank of the roadway and in that the signal is subject to a further filtering with a second time constant, in order to determine a possible offset of the signal, wherein as the input for the filter for determining the incline or bank of the roadway, a measurement signal adjusted by the output of the second filter is employed.

One thus begins with the assumption of a “normal” time lag or signal delay in a vehicle level on a certain plane, that is, a planar roadway, wherein the vehicle is not loaded. The “normal” signal delay is then the signal delay which occurs under these described reference conditions.

Under the influence of various factors, deviations from this normal signal delay occur during ongoing operation.

One of these factors is the loading of the vehicle. In the case of an even load distribution, there may not be a “slanted stance” of the vehicle in the sense of a continuous tilt or attitude angle. However, even in the case of such a loading, there results a spring compression of the vehicle, so that the distance of the sensor location from the roadway changes even in the case of a homogenous load placement in the loaded condition of the vehicle.

A further aspect in the vehicle loading is the load distribution. By an uneven load distribution in the longitudinal and/or transverse direction of the vehicle, a “slanted stance” of the vehicle can result, which likewise influences the signal delay. This has already been disclosed in mentioned DE 101 41 294 A1.

The influence of driving dynamic parameters is already described in association with DE 101 41 294 A1.

A further influence factor is the incline or bank of the roadway. This is intended to mean not only the change and therewith the difference of the roadway incline in the direction ahead of the vehicle but also the bank of the roadway in the area in which the vehicle is currently located as described in DE 101 41 294 A1. Also, in the case of a continuous incline or bank of the roadway there occurs, due to the location of the center of gravity of the vehicle, which is located above the roadway surface, a torque, which leads to a spring compression of the vehicle in the sense of a roll and/or pitch angle.

In the framework of the present invention, the influence factors can be summarized collectively to the extent that
one of the drive dynamic influences are comprised in the sense of longitudinal and/or transverse acceleration as a consequence of cornering, acceleration, and braking processes;
further, influences exist in the sense of an incline or bank of the roadway, which as a result of the location of the center of gravity of the vehicle can lead to corresponding roll or pitch angles of the vehicle;
further, influences exist, which result from a loading of the vehicle, or in certain cases also from a misalignment.

The first mentioned influence is taken into consideration by a corresponding selection of the first time constant. Cornering, acceleration, and braking have a typical time lag, which is normally shorter than the time lag in which a stretch of roadway is traveled until its bank or incline changes. The first time constant must thus be selected to be sufficiently large, that this is greater than that of the time duration for cornering, acceleration, and braking processes, so that these signal influences can appropriately be filtered out.

Here it is in certain cases also possible to vary or change the first time constant depending upon the measured longitudinal or transverse accelerations. In a steady driving straight-ahead, the time constant can be selected to be shorter than when corresponding driving situations are determined, which represent, or correspond to, a cornering or an acceleration, or as the case may be, braking process. This can be determined, for example, on the basis of an activation of the brakes, an evaluation of the acceleration, or an evaluation of the steering wheel angle. Further, the first time constant must be so selected, that the influence of the roadway bank is not lost due to an intermediate change in the roadway bank. The first time constant must thus be so selected, that the first time constant is shorter than the typical drive duration on a stretch of road with constant road bank or incline.

The coming out of adjustment, or misalignment, condition of the sensor changes generally only while in the service station. The loading changes generally only when the vehicle has stopped. This means, that the last mentioned influence can be detected with a time constant, which is greater than the first time duration, such that the there mentioned influences inclusive of the influence of the roadway bank or inclination can be filtered therefrom. Further, the second time constant must be so selected, that this time constant is shorter than the corresponding magnitude of the average duration of a drive.

The output of the filter with the second time constant is then subsequently subtracted from the measurement signal, in order to eliminate the offset of the signal. This adjusted measurement signal is used as input of the first filter, so that there the offset of the signal is eliminated, in order further from this adjusted signal to determine the bank or inclination of the roadway.

In a further inventive solution of the task according to claim 2, in a process for a signal evaluation of an environment sensor of a motor vehicle, a drive dynamic associated portion or component of the roll and/or pitch angle of the motor vehicle determined is from drive dynamic input values with use of a drive dynamic model. Further, from the signal delay or time lag, an offset of the signal is determined, as well as a bank or incline of the roadway, in that the signal is subject to a filtering with a time constant, in order to determine a possible offset of the signal, wherein for determining the bank or incline of the roadway, a measurement signal adjusted by the output of the second filter is employed, from which further the drive dynamic associated component of the bank and/or incline angle is subtracted.

In comparison to the process according to claim 1, here by means of the drive dynamic values, the corresponding component of the bank and/or incline angle is directly calculated, in order then to be able to subtract a corresponding proportion or component directly from the measurement signal. In contrast to claim 1, there is here thus the component of the error value directly subtracted from the measurement signal, so that without time lag through the filter with the first time constant, the roadway slant or inclination can be determined. In any case it is necessary, to determine the component of the roll or pitch angle dynamically using a corresponding model. Possible lack of precision in the representation by the model have a consequence on the calculation of the roadway, while this leads essentially in the solution according to claim 1 to a delay in the signal evaluation by the filtering.

In the process according to claim 3, there is determined from the drive dynamic input values with use of the drive dynamic model a drive dynamic associated component of the roll and/or pitch angle of the motor vehicle, wherein the input signal of the filter is obtained for determining the incline or bank of the roadway, in that the drive dynamic associated components of the bank and/or incline angle are subtracted from the measurement signal adjusted by the output of the second filter.

Preferably here the influence of the error or interference value or magnitude is directly subtracted, wherein by the use of the filter further signal interference can be filtered therefrom. Overall, thus, an improvement in the stability of the signal evaluation can be achieved.

In the design of the process according to claim 4, further the spring compression of the springs of the motor vehicle is determined, wherein from the compression of the vehicle and the offset of the signal a potential misalignment or misadjustment of the sensor can be determined.

From the output signal of the filter with the second time constant, the height of the sensor above the roadway can be determined. By evaluating the compression of the vehicle, it can be determined whether the vehicle is spring compressed overall as a consequence of loading (spring compression in all vehicle wheels) or whether the vehicle as a consequence of the load distribution exhibits a roll and/or pitch angle (deferential spring compression at the vehicle wheels). From this data, it can be determined which component of the offset determined as the output of the filter with the second time constant is to be traced back to the loading as well as the load distribution. From the deviation of the offset from the expected value of the offset determined by the load, as well as the load distribution, the misalignment of the sensor can be derived.

In the design or form of the process according to claim 5, a maximum is determined by an evaluation of the intensity of at least all of the measurement points associated with the roadway, which represents the breadth of a lane marker.

Preferably, the position or location of the lane marker is determined by the evaluation of the signal intensity. The intensity is differential or varying for the reason, that the lane marker compared to the normal road surface exhibits a greater capacity for reflection.

Therewith, warning systems for the approaching of the lane boundaries or steering systems for lane guidance of vehicles can be therewith controlled.

In order to reduce the complexity or expense in signal processing, signals can be consulted or drawn upon, which lie to the side of and ahead of the vehicle within a certain angular range. In this, or, in certain cases, also in other manner, for signal evaluation, only the signals need be evaluated which lie on the roadway. In an intensity image, there is searched for in certain cases, with employment of a suitable filter, a maximum of the intensity, which corresponds to the breadth of a lane marker. The positions of these maxima from each of the roadway measuring planes of the sensor can be consulted for estimating the progression of the track, track position, and track breadth.

In the design according to claim 6, the signals of measurement points which do not belong to the roadway are examined for the occurrence of associated segments.

Therewith, preferably, a roadway edge can be recognized, which could be, for example, the edge development such as for example a curb, which in the measuring can appear as an edge or curve. Thus, therewith, the road edge can be detected from these signals.

Therewith, thus the roadway progression, the roadway breadth, and the position (location) of the roadway can be recognized.

Therein for reduction of the expense and complexity in signal evaluation, preferably again all points can be left unobserved which apparently belong to the road surface. This can apply in particular for all points, which lie between recognized road lane markers.

In the further design of the process according to claim 7, there is used for estimation of the roadway progression further standing objects such as, for example, guide posts.

Advantageously, the course of the road can be better determined therewith.

For reduction of the processing complexity or effort, it is also possible here to limit the processing of the signals which are not associated with the roadway or the immediate vicinity of the road lane edge.

In the case that a sensor measuring in more than one plane is employed, it is advantageously possible to recognize whether the vehicle is experiencing spring compression as a consequence of the weight of the load or whether a corresponding signal component follows from a misalignment of the sensor or the load distribution. On the basis of the differential orientation of the two planes to the horizontal plane based on the vehicle, there are changes, in the case of an even spring compression of the vehicle, the signal delay or run times of the two planes different than in the case of a produced tilt angle.

In connection with the preceding claims 5 through 7, interrelated or coherent patterns are recognizable in an optical sensor which measures in multiple planes, in that from the evaluation of the signals of a plane, the corresponding information can be correlated.

Further, the vehicle is influenced by an uneven roadway with regard to produced pitch or roll angles. These lead to high frequency oscillation components, which cannot be resolved by sensors having a sampling rate of 20 ms to 100 ms. In certain cases, the first time constant must be so adjusted, that these signal components can be filtered.

It is in certain cases also possible, to correlate the obtained data of the above-mentioned evaluations of the road lane and the roadway. Then, depending upon the type of application, a weighting of the estimation can be undertaken, so that the optimal description of the lane, or as the case may be, roadway can be found.

### BRIEF DESCRIPTION OF THE DRAWING

An illustrative embodiment of the invention is shown in the FIGURE.

### DETAILED DESCRIPTION OF THE INVENTION

Therein, the single FIGURE shows the block circuit diagram, which represents the carrying out of the process. Depending upon the circumference within which the process is realized, it is possible that individual blocks might be dispensed with.

Reference number 1 indicates the measurement signal. This originates from a sensor, preferably an optical sensor which emits an optical signal in a plane, wherein this plane is being scanned. The reflected signal is measured with regard to the time lag or delay, as well as in certain cases also its intensity.

This measurement signal 1 is supplied to a function block 2, which represents a filter. This filter provides the second time constant in the sense of the present application. Therewith, the second time constant is meant, with in association with claim 1 was explained, and the time constant, which was explained in association with claim 2. The output signal 3 of this filter 2 is the offset of the sensor.

This output signal 3 can be supplied to a differential creator 4. The other input of this differential creator 4 is acted upon with a signal 5. This signal 5 is determined from the measured compression of the springs of the vehicle. From this data, an expected value for the offset of the sensor is determined. If by the differential creator 4 it is determined that the measured value of the offset deviates from this expected value, then a misalignment of the sensor can be concluded. This can be displayed as information output or be recorded in an error protocol. In certain cases it can also be provided that the deviation must exceed a certain threshold before appropriate measures are undertaken.

It is further to be seen that the output signal 3 of filter 2 is subtracted from the measurement signal 1. This signal 6 is supplied to a compensation device 7. This compensation device 7 is supplied with further signals, which represent the acceleration moment, brake moment, or the steering angle (or as the case may be another value, from which the yaw rate can be derived). From this, then, in the compensation device 7, the angle components of the roll and/or pitch angle are determined, which can be traced back to the drive dynamic values, so that further the corresponding component of the signal 6 can be subtracted. From this, there is produced then the signal 8.

It is also possible to determine in the compensation device 7, whether an acceleration or braking process, or as the case may be, a cornering is taking place, in order then in certain cases to change the time constant of the filter 9. In certain cases, the time constant can be changed depending upon the strength of the acceleration or brake process, or as the case may be, the radius of the curvature. In the compensation device, the corresponding drive dynamic values are preferably detected by evaluation of corresponding set positions of adjusting elements of the vehicle, or as the case may be, evaluation of corresponding wheel rotation rate. In this solution, it is not necessary to provide a vehicle model, in which concretely the effects of these influence values on the sensor signal are calculated and then taken into consideration. Preferably, the corresponding signal components are then filtered out therefrom. In this connection, it is possible, for example, in a so-called kalman-filter to provide a simplified vehicle model, in order to support the estimation of roll, pitch and lift behavior of the vehicle.

The road bank or incline is in this case apparent as constant offset in the pitch or roll angle. A roadway upswing (that is a change in the road incline) would be so to say incorporated into the measurement and would be determined separately by a further signal filtering.

The filter 9 provides or exhibits the first time constant in the sense of the above description. The output signal 10 of this filter 9 represents the incline or bank of the road.

Further, a function block 11 is shown, to which the signal 8 or in certain cases also the signal 10 can be supplied. In the function block 11 it is determined from the signal intensities where lane markers are located.

Further, a function block 12 is shown, to which the signal 8 or in certain cases also the signal 10 can be supplied. In the function block 12 there is determined from the signals, which do not belong to the roadway, whether associated segments are recognizable, which for example represent a curb stone or another significant roadway edge. Thereby, the course of the roadway edge can be recognized.

Further, a function block 13 can be seen, to which the signal 8, or in certain cases also the signal 10 can be supplied. In the function block 13, there is determined from the signals, which do not belong to the roadway, or to the roadway edge, whether routine or repetitious objects can be detected, which are, for example, guide posts. From these also the course of the road can be predicted.

The signal delay of the sensor changes in the manner that with the change in the height of the sensor due to a lowering of the springs overall or due to a pitch angle, the signal lag time uniformly changes during scanning.

During the occurrence of a roll angle, the signal delay changes on the one side compared to the signal delay on the other side, so that also in the case of scanning in one of the planes, correspondingly differential signal delays are produced.

1. A process for evaluating the signal of an environment sensor of a motor vehicle, comprising:
determining, from the signal lag time, an offset of this signal (2, 3) as well as an incline of the roadway (9, 10), comprising
(a) subjecting the signal to a first filtering (9) with a first time constant, in order to determine (10) the incline of the roadway and
(b) subjecting the signal to a further filtering (2) with a second time constant,
in order to determine (3) a possible offset of the signal,
wherein as the input of the filter (9) for determining the incline of the roadway a measurement signal (4, 8) adjusted by the output (3) of the second filter (2) is used.

2. A process for evaluating the signal of an environment sensor of a motor vehicle, wherein, from the drive dynamic input values with use of a drive dynamic model, a drive dynamic associated component of the pitch and/or roll angle of the motor vehicle is determined (7, 8), comprising:
determining, from the single run time, an offset of the signal (2, 3) as well as an incline of the roadway (9, 10), in that the signal is subject to a filtering (2) with a time constant, in order to determine (3) a possible offset of the signal, wherein for determining the incline of the roadway a measurement signal (4) adjusted by the output (3) of the filter (2) is employed, from which then components of the pitch and/or roll angle associated with the drive dynamics are subtracted (7, 8).

3. The process according to claim 1, wherein from the drive dynamic input values, with utilization of a drive dynamic model, a drive dynamic associated component of the pitch and/or roll angle of the motor vehicle is determined, wherein the input signal (8) of the filter (9) is obtained for determining the incline of the roadway, in that from the measurement signal (4), adjusted by the output (3) of the second filter (2), further the drive dynamic associated component of the pitch and/or roll angle is subtracted (7, 8).

4. The process according to claim 1, wherein additionally the spring compression status of the springs of the vehicle are determined (5), whereby, from the degree of compression of the vehicle (5) and the offset of the signal (3), a possible misalignment of the sensor is determined (4).

5. The process according to claim 1, wherein by evaluation of the intensity of at least all measurement points associated with the road lane a maximum is determined, of which the breadth corresponds to a lane marker (11).

6. The process according to claim 1, wherein the signals from measurement points, which do not belong to the road surface, are checked for the occurrence to contiguous segments (12).

7. The process according to claim 1, wherein for estimating the course of the road, also standing objects, such as for example, guide posts are used (13).

8. The process according to claim 2, wherein additionally the spring compression status of the springs of the vehicle are determined (5), whereby, from the degree of compression of the vehicle (5) and the offset of the signal (3), a possible misalignment of the sensor is determined (4).

9. The process according to claim 2, wherein by evaluation of the intensity of at least all measurement points associated with the road lane a maximum is determined, of which the breadth corresponds to a lane marker (11).

10. The process according to claim 2, wherein the signals from measurement points, which do not belong to the road surface, are checked for the occurrence to contiguous segments (12).

11. The process according to claim 2, wherein for estimating the course of the road, also standing objects, such as for example, guide posts are used (13).
